(19) United States
(12) Patent Application Publication
(10) Pub. No.: US 2022/0105612 A1
(43) Pub. Date: Apr. 7, 2022

(54) WINDSHIELD SEAL RELEASE METHOD AND APPARATUS

(71) Applicant: Craig Pennala, Delano, MN (US)

(72) Inventor: Craig Pennala, Delano, MN (US)

(21) Appl. No.: 17/337,411

(22) Filed: Jun. 2, 2021

Related U.S. Application Data
(60) Provisional application No. 63/086,625, filed on Oct. 2, 2020.

(51) Int. Cl. B25B 27/00; B25B 27/14; H05B 3/84

(52) U.S. Cl. CPC B25B 27/0028; B25B 27/0035; B60J 10/70; H05B 3/84; B25B 27/14

(57) ABSTRACT

A windshield seal heating method includes the positioning of a heating unit along a seam formed between a windshield and a window opening in a vehicle. The heating unit is turned on such that the heating unit emits heat on the windshield adjacent to the seam such that heat is transferred to adhesive which secures the windshield to the vehicle. The adhesive is heated to a temperature causing the adhesive to soften and facilitate the cutting of the adhesive.

### CROSS REFERENCE TO RELATED APPLICATIONS

This application claims priority to Provisional Patent Application No. 63/086,625 filed Oct. 2, 2020, the entire disclosure of which is hereby incorporated by reference and relied upon.

### BACKGROUND

### Field of the Invention

The invention relates generally tools and methods utilized in the removal of windshields from vehicles, and more particularly towards tools and methods that ease removal of the windshield from the adhesive seal holding it position.

### Description of Related Art

The prior art relates to tools configured for assisting a person in cutting and prying the windshield away from the vehicle and tools for cutting the adhesive around a length of the adhesive seal, particularly in colder environments. What is needed are devices and methods for reducing the effort and frustration associated with windshield removal. What is needed are tool and methods that ease the separation between a windshield and the adhesive seal holding it in. What is needed are devices and methods of windshield removal that reduces the time required for removal.

### SUMMARY

Presented herein are various example embodiments of a disclosure that meets the needs presented above by generally comprising the positioning a heat element of a heat unit of an adhesive seal release device along a seam formed between a windshield and a windshield frame defining a windshield opening in a vehicle.

In one form, the adhesive seal release device comprises one or more heat units having a heat element that produces heat when powered.

In one form, a heat element of a heat element is positioned at the junction of a windshield and a vehicle in which it is installed. The heat unit can be used by itself or in conjunction with a plurality of heat units to heat the adhesive seal until it softens to facilitate mechanically cutting the adhesive seal and removing the windshield.

In one form, the heat unit is turned on such that the heat element emits heat over the seam of the windshield such that heat is transferred to the adhesive seal which secures the windshield to the vehicle. The adhesive seal is heated to a temperature causing the adhesive seal to soften and facilitate the cutting of the adhesive.

In one form, the adhesive seal release device includes one or more heat units having a heat element that is elongated and flexible. A power supply is electrically coupled to the heat unit. A housing is attached to and covers the top side of the heating element to insulate the heat element.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a top isometric view of one embodiment of a heat unit.

FIG. 2 depicts a partial bottom view of a heat unit.

FIG. 3 is a cross-sectional view of the heat element taken along line 3-3 of the heat unit depicted in FIG. 2.

FIG. 4 depicts a partial front isometric in-use view of an embodiment of the disclosure as applied to the windshield of a vehicle.

FIG. 5 depicts a schematic view of the power flow of a heat unit in an embodiment of the disclosure.

FIG. 6 depicts a schematic view of another embodiment of the disclosure on a windshield.

FIG. 7 depicts a schematic view of a kit in one embodiment of the disclosure.

FIG. 8 depicts a flow diagram of one embodiment of a method of windshield seal release and removal.

### DETAILED DESCRIPTION OF SELECTED EMBODIMENTS OF THE INVENTION

Select embodiments of the invention will now be described with reference to the Figures. Like numerals indicate like or corresponding elements throughout the several views and wherein various embodiments are separated by letters (i.e. 100, 100B, 100C). The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

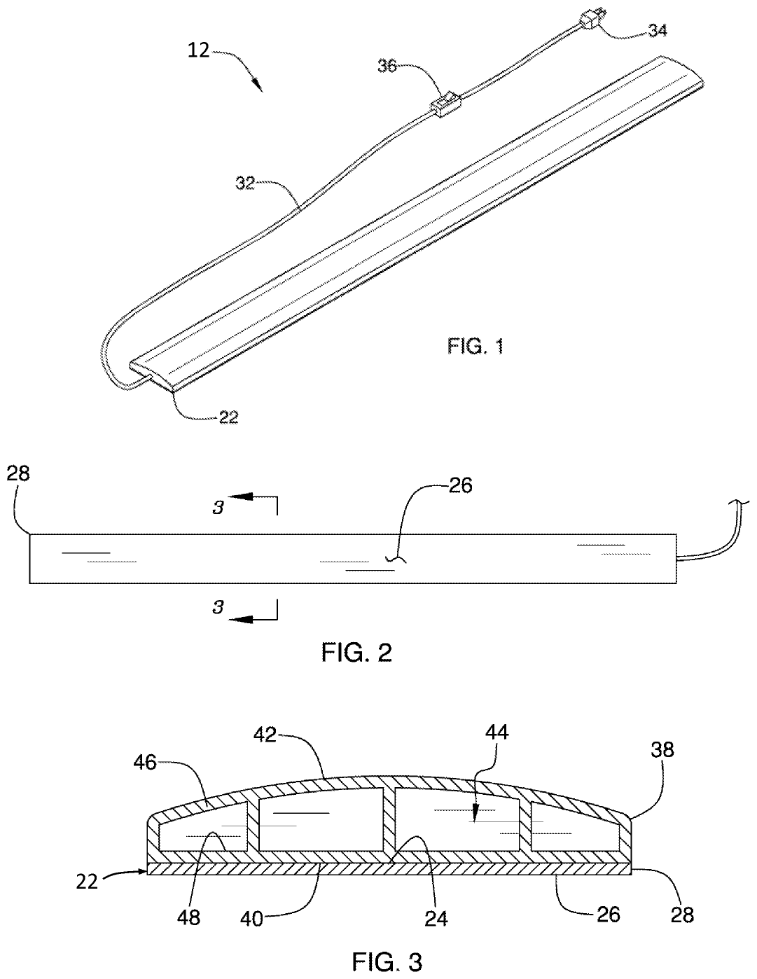

With reference now to the drawings, and in particular to FIGS. 1 through 8 thereof, a new windshield seal release device embodying the principles and concepts of an embodiment of the disclosure and generally designated by the reference numeral 10 will be described.

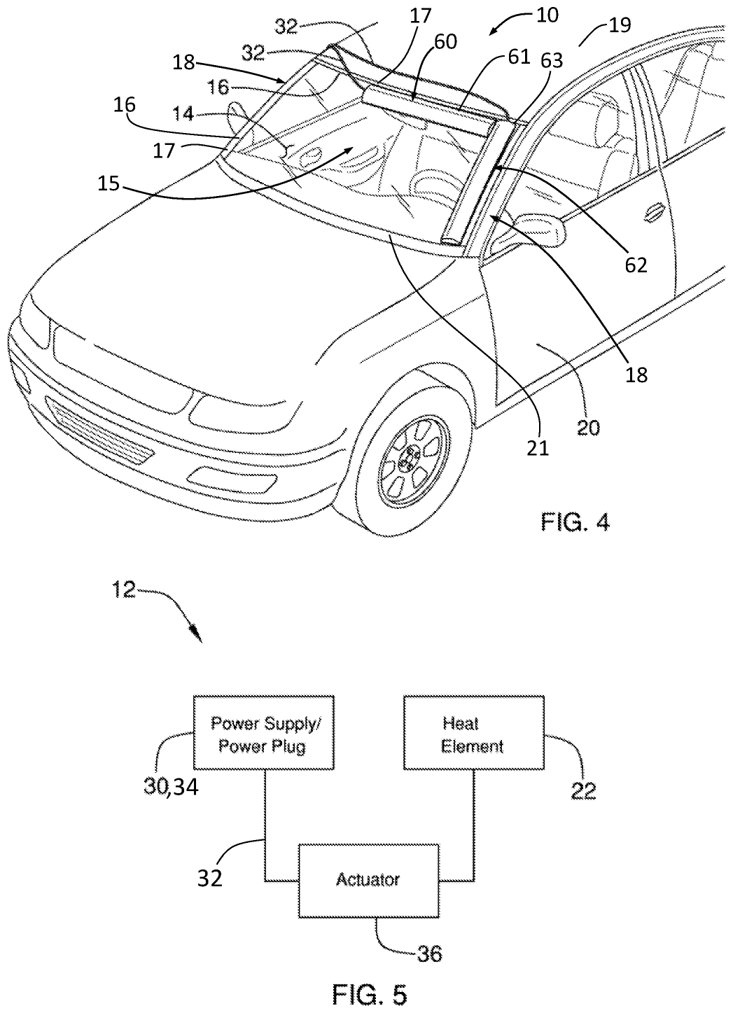

As best illustrated in FIGS. 1 through 7, a windshield seal release device 10 and method comprises one or more heat units 12. As illustrated in FIG. 4, a first heat unit 60 comprising a first heat element 61 is positioned on a windshield 14 such that it extends along at least a portion of a seam 16. In preferred embodiments, one or more of the heat units is placed on the windshield at the windshield's edge adjacent the seam. In alternative embodiments, one or more heat units is placed such that the heat element is located directly over the seam such that the heat element overlaps the windshield and window frame. In some embodiments for example, the heat element can be placed directly over a molding positioned between the edge of a windshield and windshield frame. The seam 16 is formed by conventional adhesive and is defined by an edge of a windshield 14 and a window frame 17 of a vehicle 20 in which the windshield is installed. The area where the adhesive of the adhesive seal contacts the windshield is known as the pinchweld which resides on the inner face of the windshield frame. The seam 16 is typically described as a single continuous seam extending about the perimeter of the windshield and the inside perimeter (pinchweld) of a windshield frame 17. In most embodiments, the windshield frame is defined by the vehicle's roof 19, the laterally spaced A-pillars 18, and the car body 21. A windshield can also be described as having a perimeter comprising four elongate edges of which two are substantially upright and two are substantially horizontal. In this document, a seam refers to any of the four individual intersecting seams (i.e. top seam, bottom seam, left seam, right seam) that correspond to one of the four elongate edges of a windshield.

The heat unit 12 includes a heat element 22 that is elongated and flexible for seating over the curved surface of the windshield. More particularly, the heat element 22 may be encased in an elastomeric material such as, for example, resiliently flexible silicone. Such devices may be known as flexible heaters and are widely available. One such supplier is Tempco, located at 607 North Central Avenue, Wood Dale, Ill. These types of heat elements 22 are capable of providing heat up to 200° C. However, other heat elements 22 which are flexible and elongated may be utilized provided that their heat output is sufficient for the method herein. The heat element 22 (FIG. 3) has a top side 24, a bottom side 26 and a perimeter edge 28. The bottom side 26 is planar such that it will sit flat on the windshield and this ability is further enhanced by the heat element 22 being flexible. In preferred embodiments, the heat element 22 has a length greater than 24.0 inches and typically less than 40.0 inches. In addition, in preferred embodiments, the heat element 22 has a width that is greater than 1.0 inches and which will typically be less than 6.0 inches.

As illustrated in FIG. 5, a power supply 30 is electrically coupled to the heat element 22. The power supply 30 may include a first electrical conduit 32, i.e. electrical cord, terminating in an electrical plug 34 configured for insertion into a power socket. A first power actuator 36 is electrically coupled within the first electrical conduit 32 to selectively turn off or on the heat element 22. The power actuator 36 in some embodiments comprises more than an on/off switch by further including a temperature selector. Alternatively, the power supply 30 may comprise a rechargeable battery mounted on or adjacent to the heat unit 12 for supplying electricity to the heat element 22.

As illustrated in FIG. 3, a housing 38 may be attached to and cover the top side 24 to insulate the heat element 22. The housing 38 will typically be comprised of an elastomeric material or other flexible material which will bend with the heat element 22. One type of elastomeric material that may be utilized is a vinyl methyl silicone material for its ability to withstand high temperatures as well as its insulating abilities. In one embodiment, the housing 38 has a bottom surface 40 and a top surface 42 wherein the bottom surface 40 completely covers and is one or more of but not limited to bonded, fastened, and snapped to the top side 24 of the heat element 22. The housing 38 may have an open interior 44 positioned between a top wall 46 and a bottom wall 48 of the housing 38 to prevent heat from conducting from the bottom surface 40 to the top surface 42.

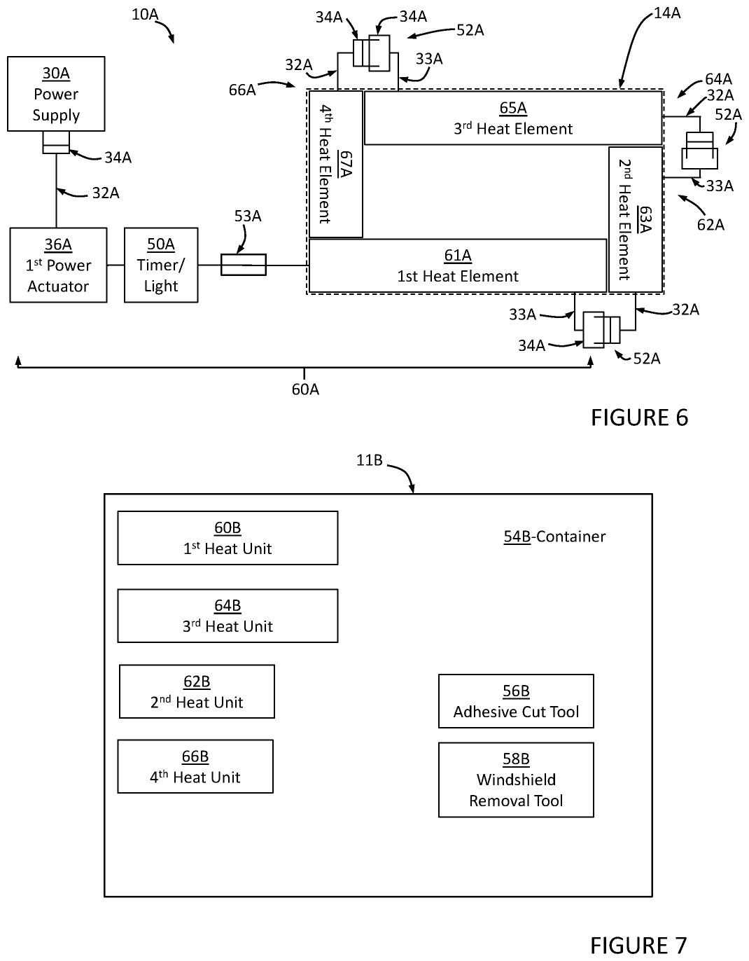

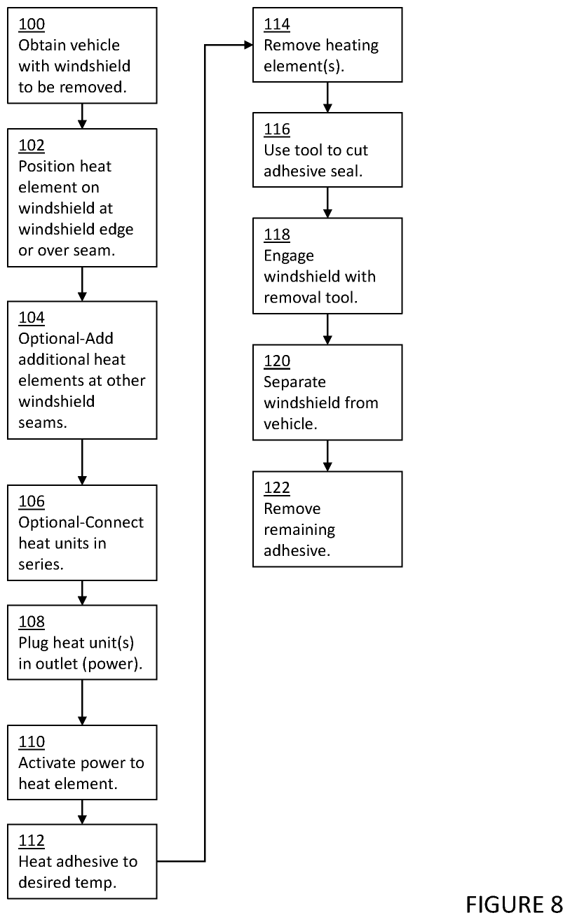

As illustrated in FIG. 8, one embodiment of a method of using a windshield seal release device comprises the following steps. A vehicle with windshield to be removed or resealed is obtained (100). The heat element of a heat unit 12 is then positioned along or over a seam 16 formed between an edge of windshield 14 and a windshield opening 15 (pinchweld) in a vehicle 20 (102). The seam 16 will be bonded with an adhesive such as a urethane adhesive. Optionally, additional heat units can be placed adjacent or over one or more windshield seams such as illustrated in FIG. 6 (104). Each heat units can be connected individually to a power supply 30A. In other embodiments, one or more of the heat units comprise both a male and a female electrical plug 34A and therefore can power the heat units in series by coupling the male and female electrical plugs as further illustrated in FIG. 6 (106). In this case, electrical plug 34A (male) is at the terminal end of first electrical conduit 32A, whereas electrical plug 34A (female) is positioned at the terminal end of the second electrical conduit 33A. The heat unit(s) are then connected by their electrical plugs to power (108). The power is then activated to the one or more heat elements (110) such that the heat element(s) emits heat on the windshield 14 adjacent to or over the seam 16. In this manner, heat is transferred to the adhesive securing the windshield 14 to the vehicle 20 (112) and heating it to a desired temperature required to soften the adhesive to facilitate the cutting process when removing the windshield 14 from the vehicle 20. This temperature, which may be considered the glass temperature for the adhesive, will vary but will typically be at least 50° and more typically at least 60° C. Once the adhesive has softened, the heat elements are removed (114) and a cutting tool is used to cut the adhesive seal (116). The windshield is engaged with a windshield removal tool (118) and the windshield 14 is lifted off separating it from the vehicle 20. Excess adhesive is scraped from the vehicle 20 (122).

Again, while a single heat unit such as first heat unit 60A may be utilized and moved sequentially to each new seam, the task of removing the windshield 14A can be removed much quicker if one or more seams are heated simultaneously in which case multiple heat units are applied simultaneously to release a large section or the entire windshield 14 from the vehicle 20. This is illustrated in FIG. 4 whereby a first heat unit 60, and a second heat unit 62 are applied simultaneously to 2 separate seams. In preferred embodiments, the applied heat elements are of similar length to the edge of windshield on which they cover.

FIG. 6 illustrates yet another example of simultaneous heating of multiple seams. In this embodiment, one or more of the heat units comprises a conduit coupling 34A of male form extending from one end of the heat unit's heat element, and a conduit coupling 34A of female form at an opposed end of the heat unit's heat element. The heat units can then be electrically connected in series like a set of Christmas lights whereby each heat element overlies the edge of the windshield 14A. In this embodiment, fourth heat unit 66A is electrically connected to third heat unit 64A by a conduit coupling unit 52A, and third heat unit 64A is electrically connected to second heat unit 62A by a conduit coupling unit 52A, and second heat unit 62A is electrically connected to first heat unit 60A again by a conduit coupling unit 52A. In this embodiment, only the first heat unit is attached to power supply 30A via electrical plug 34A (conduit coupler) and electrical conduit 32A. A first power actuator 36A, typically in the form of a switch can be optionally utilized in-line along with an optional automatic timer with indicator light 50A that will automatically shut down the adhesive seal release device 10A after a predetermined length of time or upon reaching a predetermined temperature. A fuse 53A can also be utilized in-line for circuit protection.

FIG. 7 illustrates an adhesive seal release kit 11B comprising at least a first heat unit 60B and a second heat unit 62B within a container 54B. The container can assume a variety of forms including but not limited to a bag or a box. In preferred embodiments, the windshield seal release kit 11B comprises a 1^{st} heat unit 60B, a 2^{nd} heat unit 62B, a 3^{rd} heat unit 64B, and a 4^{th} heat unit 66B for application to all four sides of a given windshield. In some embodiments, the heat units vary in length. For example, as depicted in FIG. 7, the 1^{st} and 3^{rd} heat units can be of a longer length than the 2^{nd} and 4^{th} heat units. In this case, the longer heat units are a better fit for seams at the top and the bottom of the windshield, whereas the shorter heat units are a better fit for seams on the left and right sides of the windshield. In some windshield seal release kits 11B, one or more of an adhesive cut tool 56B for cutting the adhesive and a windshield removal tool 58B for removing the windshield from the vehicle are included.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A method of softening windshield adhesive comprising the steps of:
obtaining a vehicle with a windshield occupying a windshield opening in the vehicle and whereas the windshield is secured by an adhesive seal along at least one seam between the windshield and windshield frame encircling the windshield opening;
positioning a heat element on the windshield one of adjacent and over the at least one seam;
activating power to the heat element such that the heat unit emits heat consequently heating the at least one seam; and
wherein the heat is transferred to the adhesive seal securing the windshield to the vehicle.

2. The method of claim 1 further comprising the step of:
heating the adhesive seal to a temperature of at least 60° C. thereby softening the adhesive seal.

3. The method of claim 1 further comprising the step of:
simultaneously positioning a heat unit adjacent or over each of two or more seams formed between the windshield and windshield frame.

4. A method of removing a windshield from a vehicle comprising the steps of:
obtaining a vehicle with a windshield occupying a windshield opening in the vehicle and whereas the windshield is secured by an adhesive seal along at least one seam formed between an elongate windshield edge and windshield frame encircling the windshield opening;
positioning on the windshield a first heat element of a first heat unit one of adjacent and over the at least one seam;
activating power to the first heat element such that the heat element emits heat to the at least one seam;
and cutting the adhesive seal.

5. The method of claim 4 further comprising the step of:
heating the adhesive seal to a temperature of at least 60° C. thereby softening the adhesive seal.

6. The method of claim 4 further comprising the step of:
positioning a second heat element on the windshield one of adjacent and over a second seam located between the windshield and windshield frame.

7. The method of claim 6 further comprising the step of:
positioning on the windshield a third heat element one of adjacent and over a third seam located between the windshield and windshield frame.

8. The method of claim 7 further comprising the step of:
Positioning on the windshield a fourth heat element one of adjacent and over a fourth seam located between the windshield and windshield frame.

9. The method of claim 6 further comprising the step of:
electrically connecting the first heat unit to the second heat unit in series.

10. The method of claim 6 further comprising the step of:
activating power to the second heat unit.

11. The method of claim 4 further comprising the step of:
using a tool to cut at least a portion of the adhesive seal for removal of the windshield.

12. The method of claim 11 further comprising the step of:
engaging the windshield with a removal tool.

13. The method of claim 12 further comprising the step of:
separating the windshield from the vehicle.

14. The method of claim 13 further comprising the step of:
removing remaining adhesive seal from at least one seam.

15. A heat unit for softening an adhesive seal of a windshield comprising:
an elongate heat element;
a housing;
said heat element having a bottom side operable for heating an adhesive seal disposed in at least one seam formed between an elongate windshield edge and windshield frame encircling a windshield opening;
said bottom side being substantially flat;
a first electrical conduit extending from at least one end of said housing; and
said first electrical conduit terminating in a conduit coupling unit.

16. The heat unit of claim 15 further comprising;
a second electrical conduit extending from an opposed end of said housing; and
whereas said second electrical conduit terminates in a conduit coupling unit.

17. The heat unit of claim 15 whereby said first electrical conduit is interrupted by a first power actuator.

18. The heat unit of claim 15 whereby said first electrical conduit is interrupted by at least one of a timer and a fuse.

19. The heat unit of claim 15 as part of an adhesive seal softening kit for a windshield whereas said adhesive seal softening kit further comprises:
a second heat unit comprising a second heat element; and
a container operable for housing the first heat unit and second heat unit therein.

20. The adhesive seal softening kit for a windshield of claim 19 further comprising:
at least one of a tool operable to cut an adhesive seal and a tool operable to remove a windshield.
